(19) United States
(12) Patent Application Publication
(10) Pub. No.: US 2021/0112060 A1
(43) Pub. Date: Apr. 15, 2021

(54) Method and Apparatus to Control and Monitor Access to Web Domains using Networked Devices

(71) Applicant: Appiota Inc., San Jose, CA (US)

(72) Inventors: Omar Billawala, Monte Sereno, CA (US); Rahul Gundecha, Kondhwa BK (IN); Poonam Gundecha, Kondhwa BK (IN); Mithun Baphana, San Jose, CA (US)

(21) Appl. No.: 16/949,092

(22) Filed: Oct. 13, 2020

Related U.S. Application Data
(60) Provisional application No. 62/914,402, filed on Oct. 11, 2019.

(51) Int. Cl. H04L 29/06; H04L 29/08

(52) U.S. Cl. CPC H04L 63/10; H04L 63/20; H04L 67/02

(57) ABSTRACT

A method comprising receiving a request to access a website from a requesting device, and identifying a plurality of resources on the website, provided from one or more domains. The method further comprising comparing the one or more domains to permitted domains, and denying access to the website when the domains are not the permitted domains. The method further comprising, when the website domain is a permitted domain, and a dependent resource on the website is from another domain, permitting access to the dependent domain, to fully load the website, based on permissions associated with the requesting device. In one embodiment, the system also detects keywords, and provides reporting of the detected keyword.

### RELATED APPLICATION

The present application claims priority to U.S. Provisional Patent Application No. 62/914,402, filed on Oct. 11, 2020, and incorporates that application by reference in its entirety.

### FIELD

The present invention relates to network access, and more particularly to a policy based browsing and monitoring system.

### BACKGROUND

The Internet is pervasive, and children of all ages expect to access the internet freely. However, children have no protection on the Internet from dangers ranging from pornography and scams, to cyberbullying and predators.

### BRIEF DESCRIPTION OF THE FIGURES

The present invention is illustrated by way of example, and not by way of limitation, in the figures of the accompanying drawings and in which like reference numerals refer to similar elements and in which:

FIG. 1 shows one embodiment of a Deployment diagram. The system includes a number of components.

FIG. 2 is an architecture diagram of one embodiment of the Safe Web Network system.

FIG. 3 shows the connection flow for websites when transport layer security (TLS) is used, in a standard system, without an Safe Web Network (SWN) router.

FIG. 4A illustrates the signal flow of one embodiment of HTTPS requests in presence of TLS interception proxy on the router.

FIG. 4B is a flowchart of one embodiment of the TCP/TLS handshake. The process starts at block 430.

FIG. 5 illustrates one embodiment of a runtime workflow for a client request.

FIG. 6A is a flowchart of one embodiment of access control policy enforcement.

FIG. 6B shows an exemplary domain being accessed with subdomains.

FIG. 7 shows how URL is formed by the Access Manager based on the fields provided by the HTTP parser.

FIGS. 8-9 illustrate an exemplary message flow for one embodiment of Dependent Domain detection and storage.

FIG. 10 an exemplary message flow for one embodiment of keyword detection and reporting.

FIGS. 11A and 11B show embodiments of a user on a client device searching for something that has a keyword, and the corresponding alert.

FIGS. 12A and 12B illustrate exemplary Keyword Log reports.

FIGS. 13A-13C illustrate exemplary Browsing history reports.

FIG. 14 illustrates one embodiment of the message flow with TLS certificate pinning.

FIG. 15 shows layout of Native application corresponding to the same website “domain.com” described earlier, used for the discussion below.

FIG. 16A-16E illustrate embodiments of a User Profile.

FIG. 17 is a block diagram of a computer system which may be used with the present application.

### DETAILED DESCRIPTION

System described in this document is a Safe Web Network, designed to be used in homes, schools, and/or enterprises to monitor, report and control Internet usage in the Networks.

The system can grant access to all or part of the web resources present on a certain website. It has a software proxy which acts as an intermediate broker between client devices and websites. In one embodiment, it also stores a list of allowable web resources. Every incoming web request is examined against this list or database. Based on the result of matching, the web request is either allowed or denied. In one embodiment, the system also permits a policy maker to set a list of keywords, which when found while browsing, are reported. In one embodiment, the system maintains the browsing history and makes the data available to the appropriate groups or individuals.

This is useful in various scenarios such as:
Home Networks where Parents would like to control and/or monitor the Internet access of the kids along with reports of usage;
Enterprise Networks where Internet access needs to be controlled and/or monitored and reported for the business needs;
School Networks where control and/or monitoring of Internet access is required.

For simplicity in the present application the discussion will focus on use in a home Network. However, one of skill in the art would understand that the same or similar techniques, monitoring, and reporting features may be applicable to a school or enterprise Network as well.

The following detailed description of embodiments of the invention makes reference to the accompanying drawings in which like references indicate similar elements, showing by way of illustration specific embodiments of practicing the invention. Description of these embodiments is in sufficient detail to enable those skilled in the art to practice the invention. One skilled in the art understands that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

### Glossary

This glossary defines some of terms used in the present application.

Network or Set: refers to set of client devices controlled by one or more Policy Makers. In one embodiment, the system supports separate administration of each Network by associated Policy Maker(s). The term does not refer to the physical network of the devices. Network refers to the logical grouping of the devices which may or may not be in the same physical network. In an organization that provides Laptops and Mobile devices to each employee for work, the entire organization may be considered a Network. Management may want to restrict the usage of these devices for specific tasks only. In this case the Policy Makers of the organization can impose certain policies on the devices in the Network. These policies will be effective irrespective of the physical network to which the devices are connected. For example, the mobile devices may use cellular networks whereas laptops may be using Local Area or WiFi networks. Because the Internet and other networks may also be referenced, for clarity the term Network, as defined above, will be capitalized.

Policy Makers: This term is used to refer to the category of users who set access control policies in the Network(s) under their administration. In Home Networks, typically a parent is the Policy Maker. In enterprises or schools, the network administrators and/or management team can be referred as Policy Makers. Although the term “Policy Makers” is used, it should be clear that the persons setting policies, and the persons accessing the results of those policies may be different people. Policy Makers refers to the persons or entities that control the functioning of the system, set policies, and can monitor usage in accordance with those policies, though they may be separate groupings of persons or entities.

End users: This term is used to refer to the category of users who use the Network under the restricted access. The end users will be able to access the White Listed and Partial Domains as configured by the Policy Makers. For example, in Home Networks, typically children and guests who are using the Network are considered end users. In enterprises, employees of the enterprise can be referred to as end users.

Client devices: The devices used by the end users to connect to the Internet. Mobile devices, tablets, wearables, personal computers, and other computing devices used by the end users are referred to as client devices.

Domain/Website: In this document, the terms “domain” and “website” are used interchangeably. These terms refer to the domains which offer different services over the Internet, such as web access, email service, media services etc. While “website” refers to only web resources, the “domain” is typically superset consisting of websites and other services provided at the designated location, for example FTP (file transfer protocol) and others. For the context of this document, these two terms are used interchangeably with reference to services accessible over the Internet. Although the term “website” may be used, one of skill in the art would understand that this encompasses not just webpages, but also other services provided at a URL (universal resource locator).

URLs: This refers to URL (Uniform Resource Locator) or URI (Uniform Resource Identifier) that is used to locate a domain/website resource. Website address like “https://www.example.com/news.html” is a URL. In this document we present two terms related to URLs:

Base URL: The part of a URL which contains the domain name is referred as Base URL. In above address, “example.com” is the Base URL.

Partial URL: A URL which includes additional elements beyond the Base URL is referred as Partial URL. The additional elements may be subdomains (e.g. news.example.com where news is the subdomain, or paths added to the URL, e.g. www.example.com/news, where news is the path) In the above example, “www.example.com/news.html” is a Partial URL. There may be partial URLs that have further partial URLs. For example, “www.example.com/news/2019/” is a Partial URL and “www.example.com/news/2019/june/sports.html” is a Partial URL further limiting the Partial URL of “www.example.com/news/2019/”. There may be many layers of partial URLs. A single domain can include multiple partial URLs, which may be related or unrelated.

Native applications: “Native applications” refers to those applications which are built to run on a specific operating system platform, and access Internet services. For example, any mobile application running on mobile OS like iOS or Android is referred as Native application. Internet domains and services can be used by end-users in various ways: a) using web browsers, b) native applications, c) smart devices.

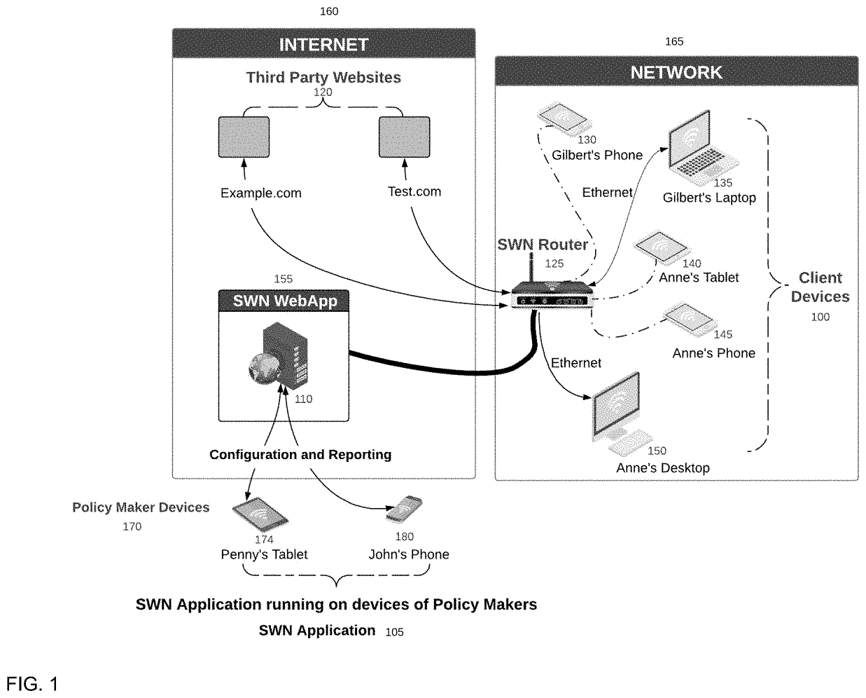

FIG. 1 shows one embodiment of a Deployment diagram. The system includes a number of components.

Client devices 100 are the devices within Network 165 which request web resources. Client devices 100 may include Smartphones 130, 145, laptops 135, Desktops 150, tablets 140, and other computing devices. The client devices 100 may be coupled to router 125 via a wired connection such as Ethernet, or via a wireless connection.

Policy Maker Devices 170 are devices 174, 180 which have the Safe Web Network (SWN) application 105 installed on them, to enable the Policy Makers to set rules, and monitor the Network use of the Client devices 100. In one embodiment, the SWN Mobile Application 105 is used by Policy Makers to configure and monitor the Internet usage of Client devices.

The SWN application 105 may be a web application or downloadable application for mobile or laptop, let Policy makers set up configurations for the system.

In one embodiment, the SWN Application 105 also displays a summary of data served by the SWN router 125.

The SWN Router 125 is a part of a Network. One or more SWN system software components are running on the router. The SWN router 125 includes an access control algorithm implemented for restricting access to the Internet 160 for client devices 100, and information gathering feature for tracking browsing activities of client devices 100, as will be described below. The SWN Router 125 and Client Devices 100 form the Network 165. The client devices 100 access various third party websites 120 via router 125.

SWN WebApp 110 is another component of the SWN software, running on a server, or in the cloud. It acts as a coordinator between SWN applications 105 and SWN Router 125. In one embodiment, Configuration data and monitoring logs are stored at SWN WebApp 110. In one embodiment, the SWN WebApp 110 also does regular data and configuration sync up with rest of the components, as will be described below.

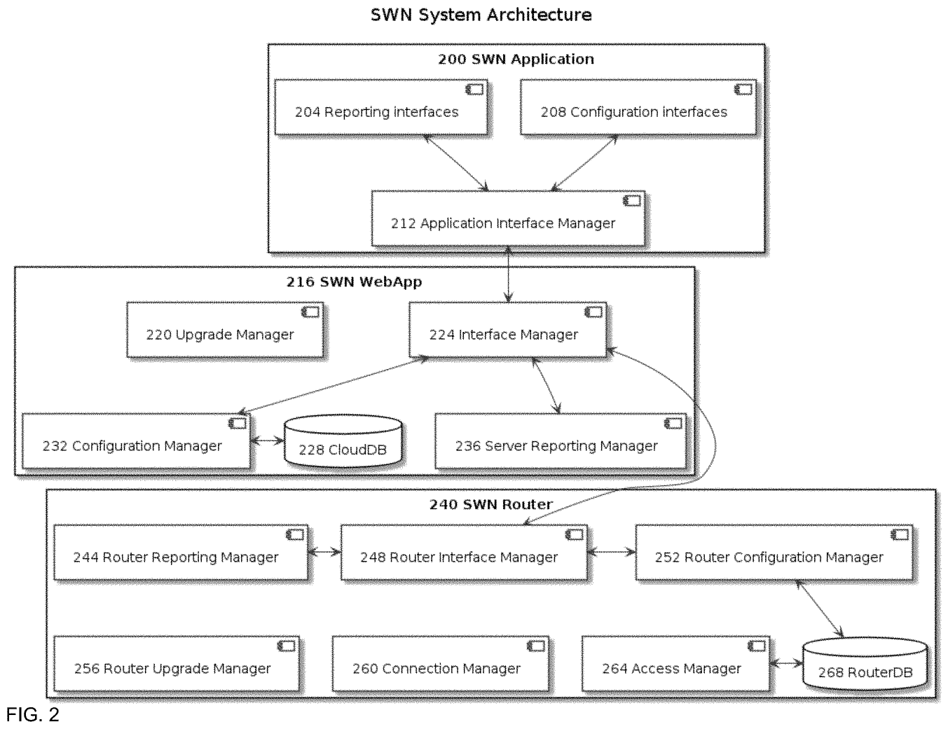

FIG. 2 is an architecture diagram of one embodiment of the Safe Web Network system. The SWN application 200 resides on a Policy maker's device and acts as a tool for Policy makers to configure access control policies and view reports/alerts of the Internet browsing activities carried out by devices. The SWN application 200 includes configuration interfaces 208 used by Policy makers to configure the parameters for access and reporting. The SWN application 200 in one embodiment also includes reporting interfaces 204, which shows various reports about end user activities. In one embodiment, the SWN application 200 also includes an interface manager 212, which acts as a gateway between application and the SWN WebApp 216, for passing data between the two sides.

The SWN WebApp 216 is software running on one or more SWN servers, and or cloud servers, which acts as a central coordinator between SWN Applications 200 and individual SWN Routers 240. The SWN WebApp 216 in one embodiment maintains a database 228 of configurations and reports.

The SWN WebApp 216 in one embodiment includes a Server Interface Manager 224, which is the gateway for passing data to/from SWN Applications 200 and SWN Routers 240.

Configuration Manager 232 manages configurations set up by the Policy makers in the Configuration database 228 and passes the relevant configuration data to different components of SWN system.

The Reporting Manager 236 maintains the reporting data sent by the Routers 240 in the Cloud database 228, and generates various types of reports for displaying in an application interface, and/or a web interface, to Policy makers, and optionally others.

Upgrade Manager 220 is responsible for managing upgrades of the software running on the Routers 240. In one embodiment, the Upgrade Manager 220 may also manage upgrades to the Applications 200 used by Policy Makers.

Cloud Database 228 is a database which contains the Policy makers account data, configuration data, reporting data and related metadata. Note that although this is illustrated as a single database, one of skill of in the art would understand that this data may be distributed in separate databases, such as a configuration database, a reporting database, a policy database, etc. and may be stored in the cloud.

SWN Router 240 includes software that controls the Internet traffic based on the Access Control policies configured by the Policy maker. The router 240 also monitors and reports the browsing activities of the devices. In one embodiment, the SWN router 240 includes a number of application modules.

The router Interface Manager 248 provides the gateway between Router software and WebApp 216 for passing data from both sides

The router database 268 a local copy of the configuration data related to the Router 240. In one embodiment, the configuration data enforces the access rules to the client devices in the Network.

The router Configuration Manager 252 maintains the Router DB 268, and receives updated data from the SWN WebApp 216.

The Connection Manager 260 is responsible for managing the connections with client devices connected to the Router 240 and the connections with third party websites on the Internet.

The Access Manager 264 makes the access control decisions based on the configuration data in Router DB 268.

Router Reporting Manager 244 collects the data about various activities of the devices connected to the SWN Router 240, and generates data for the reports. In one embodiment, the router reporting manager 244 prepares the reports to be shared with WebApp for further processing. In another embodiment, the router reporting manager 244 provides the data to the WebApp 216, and the server reporting manager 236 processes the data to generate reports. The responsibility for generating reports may be shared between router 240 and WebApp 216.

Router Upgrade Manager 256 ensures that any upgrades of the Router software are applied. In one embodiment, the Router software may be able to accept run-time upgrades.

SWN system provides safe browsing for client devices. Safe browsing includes one or more of the following: whitelisting (complete or partial), search keyword reporting, and browsing history reporting.

Complete or Partial whitelisting of websites enables the granting of access to whole or part of a website/domain. Prior art mechanisms provided only the ability to block the entire website/domain, or permit access to the entire website/domain. A mechanism to allow access to part of a domain is provided by the SWN system, as will be described in more detail below. Additionally, the system permits Whitelisted sites to load content from other sites that are not whitelisted, as will be described below.

In one embodiment, keywords are identified when they are used in searches. In one embodiment, keywords may also be identified when shown in search results as well as during browsing. The system provides reporting of such keywords. This enables tracking of client device user's potentially problematic behavior, even if they are unable to successfully access such sites through the client device. In one embodiment, occurrence of specific keywords within the data entered by the users on the client devices while browsing is detected and reported. In one embodiment, this reporting is in real time.

In one embodiment, browsing history is also reported. In one embodiment, the history provides details about domains visited, the amount of data consumed, and amount of time spent.

SWN system provides an end-to-end framework for Policy Makers to configure and enforce the Access Control policies for the client devices in the Network based on completely whitelisted or partially whitelisted domains. Access control policies are effective for the traffic over both HTTP and HTTPS protocols. In one embodiment, traffic belonging to unsupported protocols is not blocked.

Following table lists one embodiment of the different categories of the domains for access control policies:

| | | Configuration to be |
|---|---|---|
| Domain categories | Description | done by Policy Maker(s) |
| Blocked domains | These domains are not accessible except | No |
| (default category) | if particular request is classified as | |
| | “Dependent domain” as mentioned below | |
| Dependent domains | If some request belonging to Blocked | No |
| | domains is required in order to load | |
| | the complete web resource belonging | |
| | to Whitelisted or Partial domain, then | |
| | that particular request is allowed | |
| Whitelisted domains | These domains and their sub-domains | Yes |
| | are completely accessible | |
| Partial domains | Only the specified part(s) of these | Yes |
| | domains are accessible | |

In one embodiment, by default, all domains are blocked. There is no specific configuration needed for the blocked domains, and every domain is blocked unless whitelisted explicitly. In another embodiment, the default configuration includes some “safe” domains, such as school domains, or well-known educational domains.

When a user tries to access a blocked domain, in one embodiment a “blocked page” indicator is displayed by SWN system. In one embodiment, the blocked page display may be customized. In one embodiment, the blocked page indicator provides an option to send domain unblock request to the Policy Maker(s).

To grant access to a domain, the Policy Maker explicitly whitelists that domain, in one embodiment. In one embodiment, the Policy Maker may temporarily white list a domain, or white list the domain only for a requesting user rather than for all end users on the system, as will be discussed below.

Users can access domains in the completely whitelisted domain category without any restriction. All the URLs and all the sub-domains belonging to the completely whitelisted domains are accessible to the users. For example, if google.com is whitelisted then all the services available under google.com will be available. This means Google Maps (google.com/maps), Google Play Store (play.google.com), Google Search (google.com/search), etc. will be accessible to the users.

Partially whitelisted domains are the domains whose content is to be allowed partly. This means that the full domain may not be accessible, but one or more parts are allowed. Policy Maker(s) configure the Partial URLs to be allowed, in one embodiment. The content from the specified URLs, and their subdomains and/or URLs including the Partial domain and paths, will be accessible, but anything apart from those URLs remain blocked.

For example, if Google.com is partially white listed, by whitelisting google.com/maps then only the services available under google.com/maps will be available. This includes google.com/maps as well as “https://www.google.com/maps/place/san%20francisco”. However, anything that has the domain google.com/X where X is not “maps” would remain blocked. This means that results from Google Maps will be accessible while Google Play Store (play.google.com or google.com/play), Google Search (google.com/search), etc. will be not accessible to the users.

There are dependencies among different domains. Typically there are numerous web resources embedded on any web page. Web resources which are loaded in order to present the complete web page/resource are referred as embedded resources in SWN system. Embedded resources may belong to domains different than the configured whitelisted or partial domains. In such cases, SWN system refers to these domains as “dependent domains”. The domain of page on which they are embedded, that is the website on which these resources are needed, is referred to as the “parent domain” in the SWN system.

In one embodiment, all completely white listed domains automatically permit access to the subdomains associated with the completely white listed domain.

SWN system provides an easy way for Policy Makers to enter the desired list of whitelisted domains through a configuration interface on the SWN application. The Policy Makers are able to implement the access control policies of their choice with minimal effort. Access to this interface is protected by the Policy Maker's credentials. In one embodiment, the credentials use two-factor authentication. In one embodiment, the credentials require access to a registered device, such as the Policy Maker's mobile device. The interface provides lists of existing Whitelisted domains, including Complete and Partial Domains, and enables the Policy Maker to add new whitelisted domain(s) and delete existing whitelisted domain(s). Changes made by Policy Makers using this interface are stored in the database on SWN WebApp and pushed to the corresponding Router(s) for implementation.

In one embodiment, Policy Maker(s) can flag specific words known as “keywords”. In one embodiment, whenever these keywords are searched for on client devices, SWN will report the event to Policy Maker via app notification. This helps in monitoring potentially harmful or suspicious activities of end users. In one embodiment, for some keywords the notification may be immediate.

For example, Policy Maker(s) can configure “bluewhale” as a word to monitor, and if an end user searches for “bluewhale,” which is a game which is infamous for addiction and provoking suicidal tendencies, the Policy Maker is alerted. In one embodiment, keywords in a website name and/or URL may be detected. In one embodiment, keywords in data sent from the client device are detected. In one embodiment, keywords in data received from a website may be detected.

This section describes one embodiment of the details of TLS interception proxy works in general and why it is being used in the SWN router.

### Connection Flow

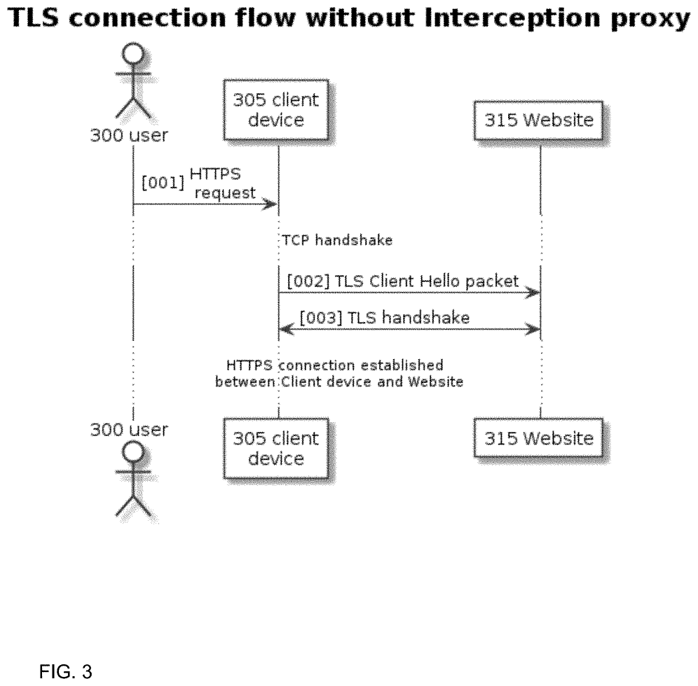

FIG. 3 shows the connection flow for websites when transport layer security (TLS) is used, in a standard system, without an SWN router. When a website is accessed via HTTPS, TLS is used. As shown in FIG. 3, the user 300 make a request, and the client device sends a TLS client hello packet to the website 315. The TLS handshake between website 315 and client device 305 is completed, and the TLS connection gets established in between client device 305 and website 315 directly.

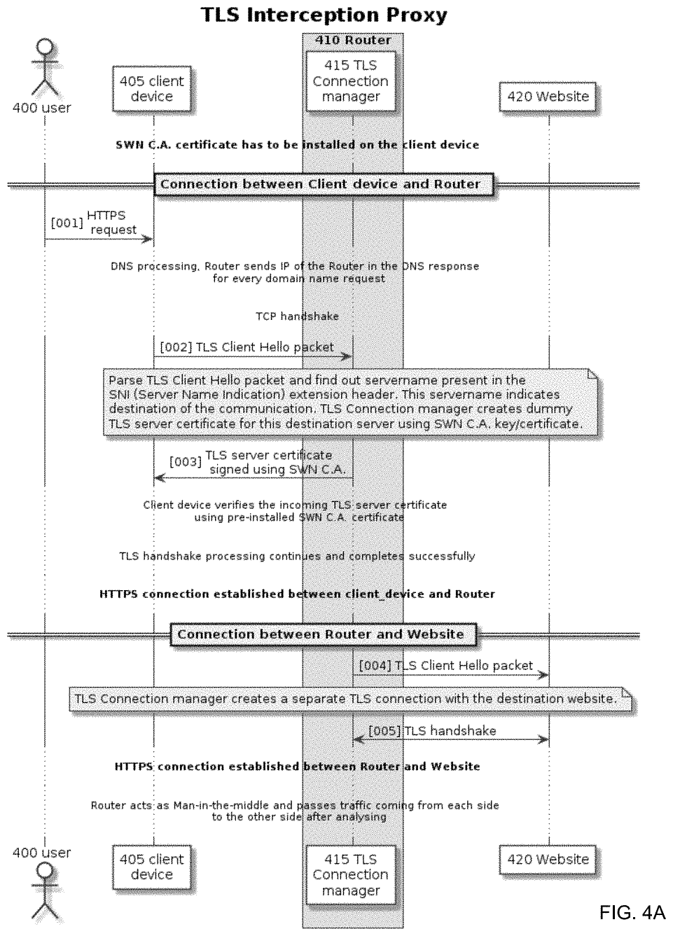

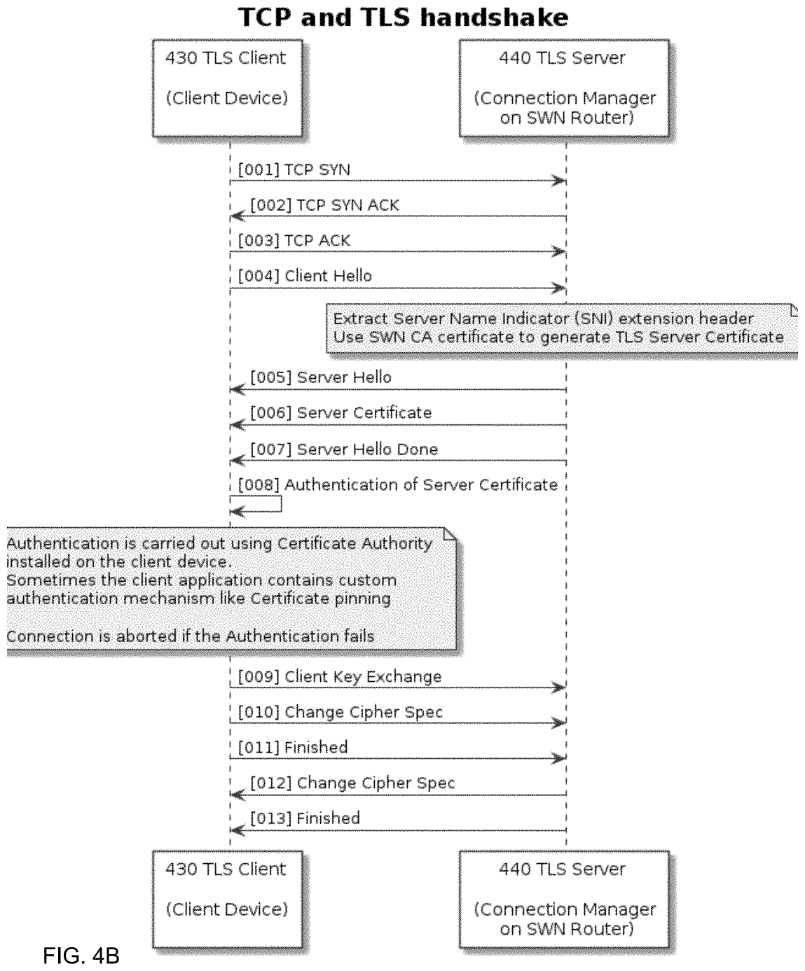

FIG. 4A illustrates the signal flow of one embodiment of HTTPS requests in presence of TLS interception proxy on the router. The user 400 initiates an HTTPS request, through client device 405. There is an established connection between the client device and the router, as is normal. In one embodiment, the client device 405 includes an SWN CA (Certificate Authority) certificate. In one embodiment, each of the client devices which are part of the Network include such an SWN CA. The Router uses same SWN CA certificate to generate TLS server certificates for websites requested through incoming TLS requests. The SWN CA certificate ensures that the client device 400 trusts the TLS connection with Router.

Whenever client device sends the DNS requests, SWN Router prepares a DNS response which utilizes the Router IP as the IP for the requested domain name. Due to this DNS response, the client device sends TLS packets with the destination IP as the Router IP.

TLS connection gets established in between client device 405 and Router 415.

The Router acts as Man-In-The-Middle and creates a separate TLS connection with the requested website. There are two distinct connections which have one endpoint each on the Router, the TLS connection with between the router and the client, and the TLS connection between the router and the website 420.

Router receives the data from both connections. It analyses the data from the website to ensure its compliance with the filtering settings for the SWN system, e.g. whitelisting. After that, if the data does not trigger any issues, it forwards the data to the client connection, via a connection other than the one on which it received the data. If the connection is not whitelisted, e.g. the request is to a blocked domain, the Router terminates the connection. In one embodiment, a blocked site page is displayed to the end user 400.

The data flow is as follows. A User 400 sends an HTTPS request for a web resource. The user may request to browse a web domain using the Web browser or via any application on the client device.

Client device 405 sends a DNS request to the Router 410 for the requested web domain.

The router 410 provides its own IP address as the IP address for the requested web domain.

Client device 405 initiates the standard TCP handshake with Router IP address received in the DNS response. The TCP handshake is completed and a TCP communication channel is established for communication between the client device 405 and the router 410.

FIG. 4B is a signal flow of one embodiment of the TCP/TLS handshake between the client and the connection manager in the router.

In case of HTTPS requests, client device initiates the TLS handshake with the Router. Connection Manager of the Router is running a TLS server, and receives the TLS handshake request.

The Connection Manager, running on the Router, generates a TLS server certificate for the web domain being requested by the client device. The requested web domain may belong to any of the following categories: configured Whitelisted domain, configured Partial domain, Dependent domain, or Blocked domain.

The Connection manager extracts the Server Name Indicator (SNI) extension header from the incoming TLS packet to find out the requested web domain name.

The SWN CA certificate is used by the Connection manager to generate the TLS server certificates. The Connection manager continues with the TLS handshake process with the client device using the generated server certificate.

The Client device receives the TLS server certificate from the Router. The client device verifies the server certificate, using the trusted list of Certificate Authorities (CA). The SWN CA certificate is present, as a trusted certificate, on every client device. Installation of the CA certificate ensures that any TLS server certificate created using that CA certificate is trusted by the client device.

Thus, the secure communication channel is established between the client device and the Router, because the handshake is completed by following the standard TLS protocol.

In parallel with the above, the router establishes a secure connection with the third party website requested by the client device. (not shown)

The router determines whether the third party website can be presented to the user. As noted above, only websites that are white listed, partially or completely, are shown.

If the website is not approved, a blocked site page is displayed to the user. In one embodiment, the user may request approval of the site. In one embodiment, this may be done by clicking on a “request access” button on the blocked site page.

If the website is approved, the website is displayed, through a secured connection, to the client device. The secured connection (HTTPS) is between the client and the router, and a separate secured connection is between the router and the third party website. Thus, the data traverses to the client through the router.

In this way, the system can provide access to HTTPS websites, establishing secure connections, while still providing the protection of ensuring that inappropriate content is not shown to the users.

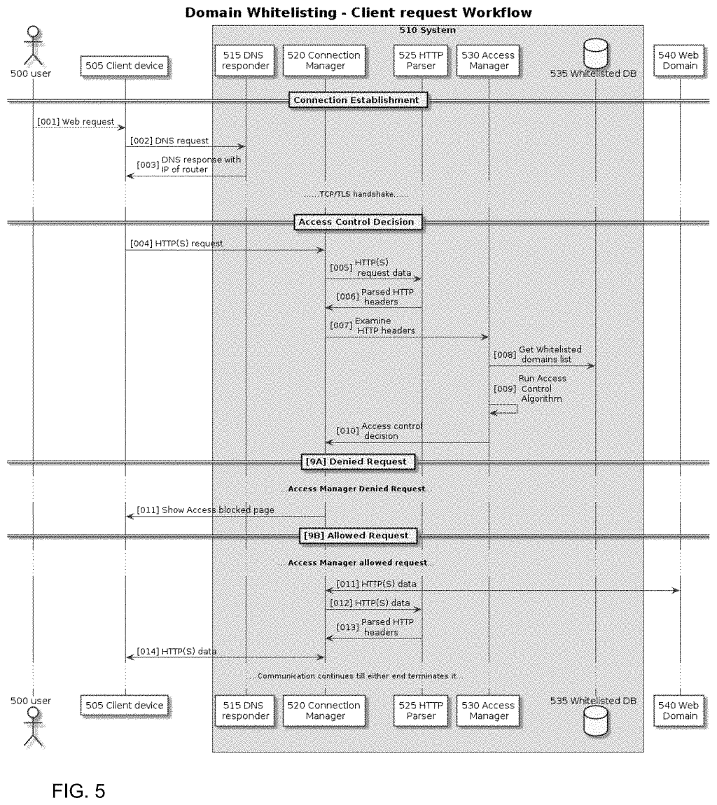

FIG. 5 illustrates one embodiment of a runtime workflow for a client request. The process of Access control on HTTP(S) connection traffic is illustrated.

The user initiates a web request (1). The client device sends a DNS request to the router (2). The DNS responder within the system returns the IP address of the router device (3). The TCP/TLS handshake, establishing the secure connection between the client device and the router occurs after receiving the IP address.

For the access control decision, the Client device starts by sending HTTP(S) data to Router (4).

The Connection Manager sends the received data to HTTP parser module for detecting and extracting the HTTP headers (5). The example of the HTTP parser discussed is focused on to HTTP(S) traffic implementing to HTTP version 1.1. One of skill in the art would understand how to modify these elements to address updated versions.

Multiple HTTP(S) requests can come on same HTTP(S) connection in sequential order—first request followed by response to that request, then second request followed by second response and so on.

HTTP parser detects and notifies the occurrence of every new HTTP request to Connection manager. If a new HTTP request is encountered, an Access control decision is made for that request. HTTP parser also parses incoming data, identifies HTTP headers and extracts fields like HTTP Host, URI, Referer, and Content type from the HTTP headers. These fields are used by other modules like Access Manager, Reporting Manager. the HTTP parser returns the parsed HTTP headers to the connection manager (6).

The Connection Manager forwards the HTTP headers to Access Manager for further examination (7).

Access Manager loads the completely whitelisted domains and partially whitelisted domains list from the local database present on the Router (8). In one embodiment, this is done each time a request is received. In another embodiment, the data is refreshed periodically.

Access Manager determines whether to allow the incoming request or not (9). The decision is based on the whitelist configuration and HTTP header fields. More details are described of one embodiment of this determination is described below.

The Access Manager notifies the Access control decision to Connection Manager.(10) The decision has two possible outcomes: allow the request or Block the request. Based on the outcome, Connection Manager carries out the further steps.

If Access manager directs the connection manager to block the request then the connection manager sends HTTP REDIRECT response to the client device and closes the connection. HTTP REDIRECT response redirects the client device to display an “ access blocked page” (11). This blocked page shows a warning message to the user. In one embodiment the page also provides a mechanism to request the unblocking of the Web domain. In one embodiment, the mechanism to request unblocking includes a button which notifies the Policy Maker of the request, to which the user may add an explanation/reason.

If the Access manager directs the connection manager to allow the request, then the Connection manager resolves the IP address for the requested web domain. It then initiates and establishes a TLS connection with that external web domain by acting as a TLS client.(11)

Connection manager is now connected to the two distinct parties:

Connected as a TLS server to the client device in the Network b) Connected as a TLS client to the external web domain in the Internet

This way the SWN Router software acts as a TLS proxy (MITM—Man In The Middle) by implementing TLS server and TLS client profiles. All the data coming from one end can be decrypted by the connection manager and examined. Connection manager forwards the decrypted data to HTTP parser for the examination.

In one embodiment, the HTTP parser parses the entire HTTP request from the client device, including HTTP headers, and payload data. In one embodiment, the HTTP parser parses only the HTTP headers of HTTP responses coming from the websites. The payload data is examined to detect the end of the payload. The Connection Manager passes the data received from the server to the client device

In one embodiment, Reporting Manager receives the parsed data from Connection Manager. Reporting Manager examines the data to capture information about the client device's Browsing history, Bandwidth consumption, and Keyword use. Reporting manager prepares reports, and passes those to WebApp to make them available to the Policy Maker.

Access Manager makes the decision to allow or block an incoming request based on the Data provided by HTTP parser about incoming data which includes HTTP headers like Host, URI, Referer, and the Configuration data present in local whitelisting database.

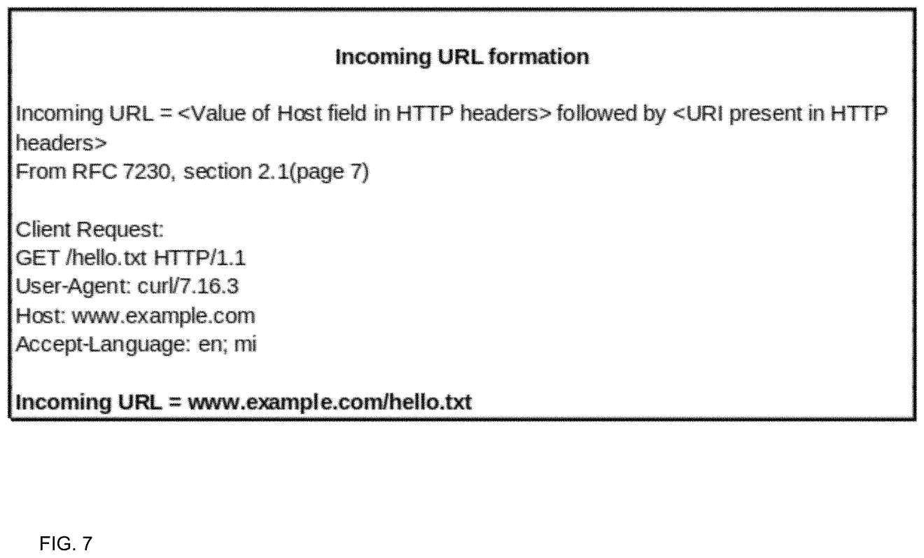

In one embodiment, the Access Manager provides Incoming URL formation. FIG. 7 shows how URL is formed by the Access Manager based on the fields provided by the HTTP parser.

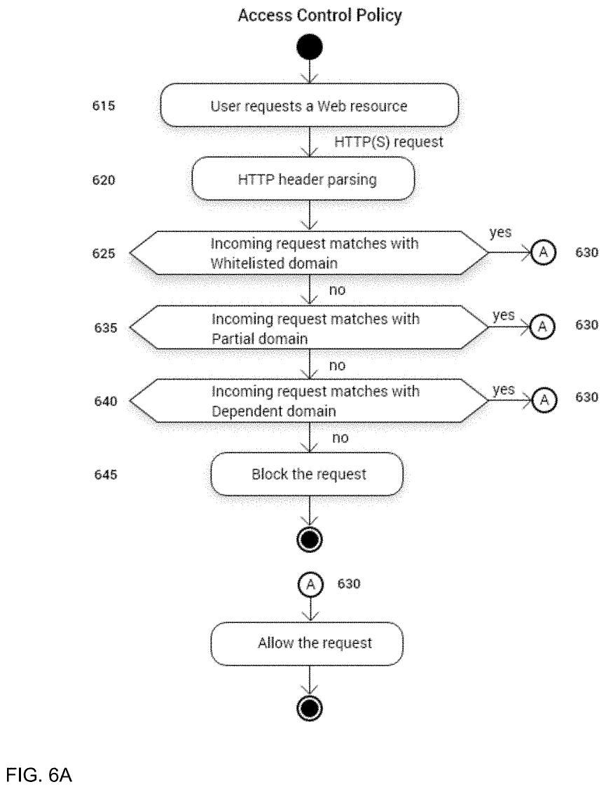

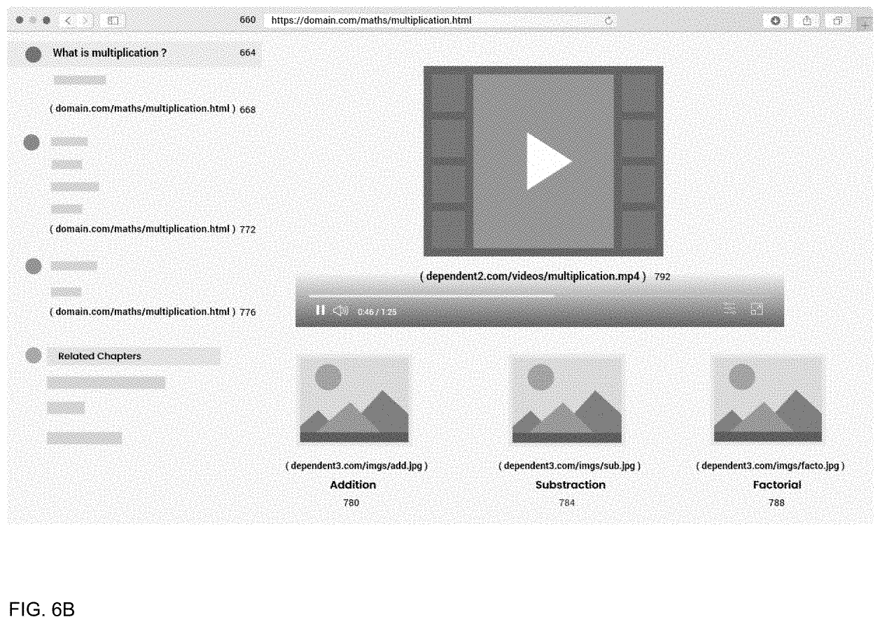

FIG. 6A is a flowchart of one embodiment of access control policy enforcement.

At block 615, the user requests a web resource.

At block 620, the HTTP headers are parsed.

At block 625, the incoming URL is matched with list of completely whitelisted domains. If URL belongs to any of the Completely Whitelisted domains then the request is allowed, at block 630.

At block 635, incoming URL is matched with list of partial domains. Any URL which is an extension of some configured Partial Domain, which adds a path and/or subdomain to a permitted Partial Domain, is allowed by the system, at block 630. In one embodiment, the system assumes that the URL is extended only if there is one of the following special characters suffixed to one of the Partial Domains: ‘=’ (equal to character), ‘/’ (slash), ‘&’(ampersand). These special characters are the typical delimiters used inside the URI. RFC 3986 describes the URI syntax.

For example, there are various images present on following path for a web domain: domain.com/images. Policy Maker at one enterprise wants to allow access to all the images which are within the domain. This Policy Maker adds “domain.com/images” as a Partial Domain. In contrast, if a Policy Maker at another enterprise wants to allow access to only some of the images on this domain which are located at the following URLs: “domain.com/images/rectangle.jpg” and “domain.com/images/mountain.jpg” then that Policy Maker adds these two URLs as two separate Partial Domains.

Returning to FIG. 6A, at block 640, if incoming URL did not match with any of the whitelisted domains, whether completely whitelisted or partially white listed, then it is examined for dependent domain matching. If incoming URL is marked as dependent domain then that particular request is allowed.

If the requested web resource is not from a Whitelisted or a Partial domain then the dependent domain detection check is carried out. In one embodiment, the SWN system detects Dependent domains on run-time basis. In one embodiment, when present, the system uses the “Referer” field in the HTTP request header. If Referer field contains Whitelisted domain name, or a Partial Domain name, then the requested domain is categorized as a Dependent domain and domain present in Referer field is treated as a Parent domain in SWN system. When the Parent Domain is White Listed, or partially white listed, the dependent domain is allowed.

The Referer field can include the domain name or a URL which contains the domain name.

For example, when a user is browsing “domain.com” website, a white listed domain, the website requests access to web resources belonging “dependent2.com” and “dependent3.com.” These requests reach the Router. In both of these requests, the Referer field contains “domain.com”. Hence both of these domains are identified as dependent domains, and permitted. FIG. 6B shows an exemplary layout for the “domain.com” website. There is an embedded video which is sourced from “dependent2.com” and there are images that are coming from “dependent3.com” domain. Thus, to fully load this webpage, the portions of it served from the dependent2.com and dependent3.com domains need to be loaded as well. This is why Dependent Domains are identified and permitted to load by the router.

There are cases when Referer field can be absent in HTTP headers. Typically this is the case when requests are generated from some native applications running on mobile devices. For example, on mobile devices like iOS or Android based devices there are mobile applications; or on Windows or Mac machines there are similar applications built to run specifically on that OS itself. One embodiment of addressing such a situation is described below.

In one embodiment, Dependent domains detected using above method are stored locally in the Router database along with the domain which referred them.

The mapping of “domain.com” as Parent domain and “dependent2.com” & “dependent3.com” as its Dependent domains is stored in the Router database. In one embodiment, the mapping data stored in Router database is synced periodically to WebApp database. This mapping may be used in connection with future requests, so that the system need not perform the standard detection mechanism where standard detection mechanisms may not work due to the absence of the Referer field. This is subject to the user profile settings, as discussed below. In one embodiment, this mapping may be carried forward to other systems that share the same permissions from Policy Makers.

The requests to Dependent domains are allowed upon detection. In the above example, requests to web resources loading from websites “dependent1.com” and “dependent2.com” will be allowed, since their Parent domain is whitelisted.

Note that the request for a domain permitted as a Dependent domain, but not whitelisted, may be made directly by the user or by some other domain that is not white listed. In such cases, that particular request is not classified as “Dependent domain” request, hence not allowed.

Returning to FIG. 6A, if the request does not match White Listed Domains, Partially Whitelisted Domains, or Dependent Domains, the request is blocked, at block 645. The process then ends.

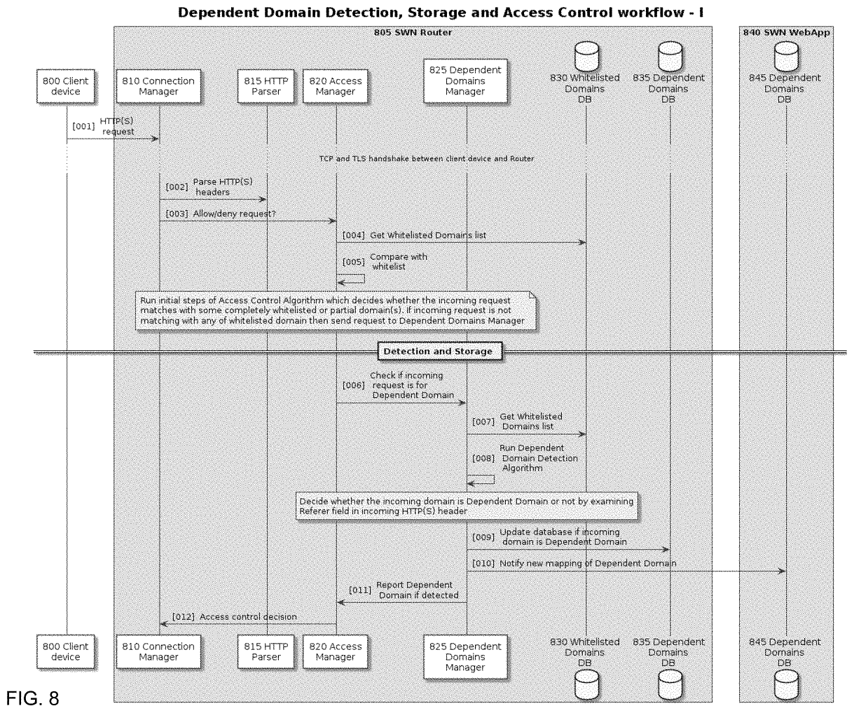

FIG. 8 is an exemplary message flow for one embodiment of Dependent Domain detection and storage. When the client device 800 sends an HTTP(S) request to the connection manager 810 in the router (1), the headers are parsed (2) by the HTTP parser 815. The access manager 820 is queried to determine whether to allow or deny the request (3). The access manager 820 in one embodiment obtains the white listed domains list from the database (4) 830, and compares the requested domain with the white list (5). In these initial steps the access control system determines whether the incoming request matches with a completely whitelisted domain or partial domain. If the domain does not match either, then the dependent domain analysis is initiated.

The system determines whether the incoming request is for a dependent domain (6) by requesting that data from dependent domains manager 825. The dependent domains manager 825 obtains the whitelisted domains list (7) from white listed domains database 830, and runs a dependent domain detection algorithm (8). In one embodiment, the detection algorithm utilizes the Referer field in the header to determine whether the domain is a dependent domain.

If the dependent domains manager 825 determines that the domain is a dependent domain of a white listed domain, then the dependent domains database 835 is updated (9). In one embodiment, the SWN server's dependent domain database 845 is also updated (10). The dependent domains manager 825 also reports whether a dependent domain was detected (11) to the access manager 820. The access manager 820 returns the access control decision (12) to the connection manager 810, which either permits the connection or denies it.

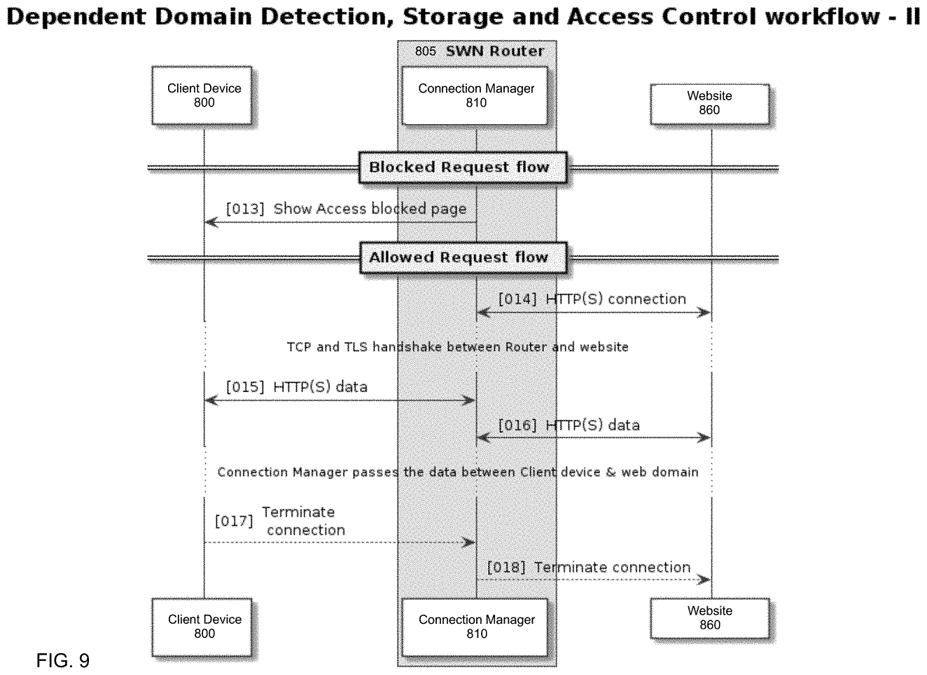

FIG. 9 continues the flow of FIG. 8, addressing how blocked and allowed requests are addressed in one embodiment of the Dependent Domains Access Control.

If the connection manager identifies the requested page as a blocked domain, For a blocked request, the access blocked page (13) is shown by connection manager 810 to client device 800. The access blocked page, as noted above, in one embodiment allows the user to request access with a single click.

If the access is a allowed, e.g. the requested domain is a white listed domain or partially white listed domain and the request is to the portion white listed, the connection manager 815 establishes an HTTP(S) connection (14) with the website 860. A TCP/TLS handshake is established between the router and the website. The HTTP(S) data sent (15) by the client device 800 to the website 860 is forwarded by connection manager 810 to the website. The HTTP(S) data sent (16) by the website 860 to the client 800, is forwarded through the connection manager 810. The connection manager passes the data between the client device 800 and website 860, enabling it to continue monitoring the content being passed, and ensuring security. When the client device terminates the connection (17), the connection manager 810 in turn terminates the connection (18) with the website 860.

In this way, the system can ensure compliance with the policies, and enable client devices 800 to request and receive only appropriate data from websites 860.

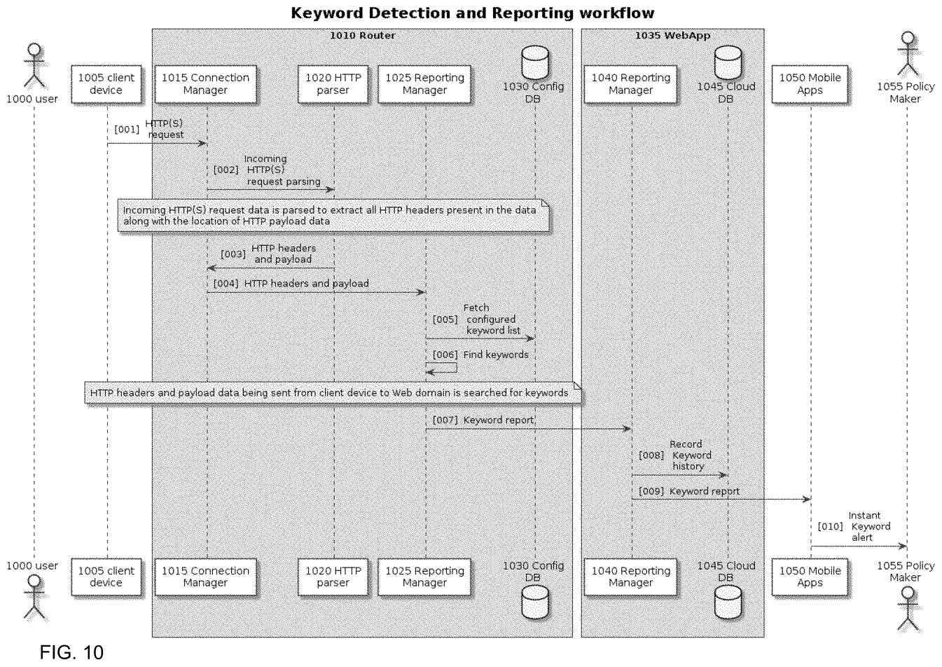

FIG. 10 an exemplary message flow for one embodiment of keyword detection and reporting. In one embodiment, the data transmitted from the client device connected to the Router is scanned for occurrences of keywords configured by the Policy Makers. When the client device 1005 sends an HTTP(S) request (1), it is passed (2) to HTTP parser 1020 by connection manager 1015. The data is parsed to extract the HTTP headers, and the location of the HTTP payload data.

The payload and header data are returned (3) by the HTTP parser 1030 to the connection manager 1015, in one embodiment. They are then sent to the reporting manager 1025.

Reporting Manager 1025 receives the HTTP headers and HTTP payload data from Connection Manager 1015. Reporting Manager 1025 fetches the keyword list (5) from configuration database 1030, and scans this data to check if there is any keywords found inside this data (6).

If it finds the keyword, then a report is generated and sent (7) to WebApp 1035's server reporting manager 1040. WebApp's reporting manager 1070 records the keyword history (8) in the cloud database 1045, and passes the keyword report (9) to the Policy Maker's mobile device 1055. The application 1050 on the Policy Maker's device in one embodiment generates an alert (10) and pushes the notification for the corresponding Policy Makers. In one embodiment the alerts are optional, and may be associated with a subset of keywords. For example, keywords associated with suicide or drug use may send immediate alerts, while keywords associated with less concerning issues such as a prohibited gaming application may simply provide a keyword report, rather than sounding an immediate alert.

Since Connection Manager acts as TLS server for the HTTPS connections coming from the devices, it can read the encrypted TLS data as well.

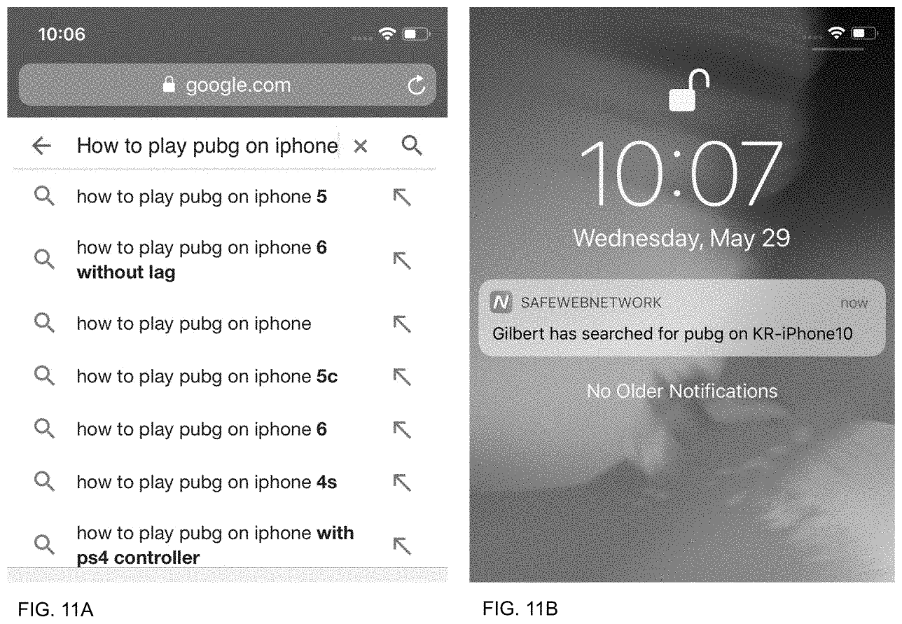

FIGS. 11A and 11B show embodiments of a user on a client device searching for something that has a keyword associated with it (here “pubg”), and the corresponding immediate alert on the Policy Maker's device, showing the alert and associated keyword.

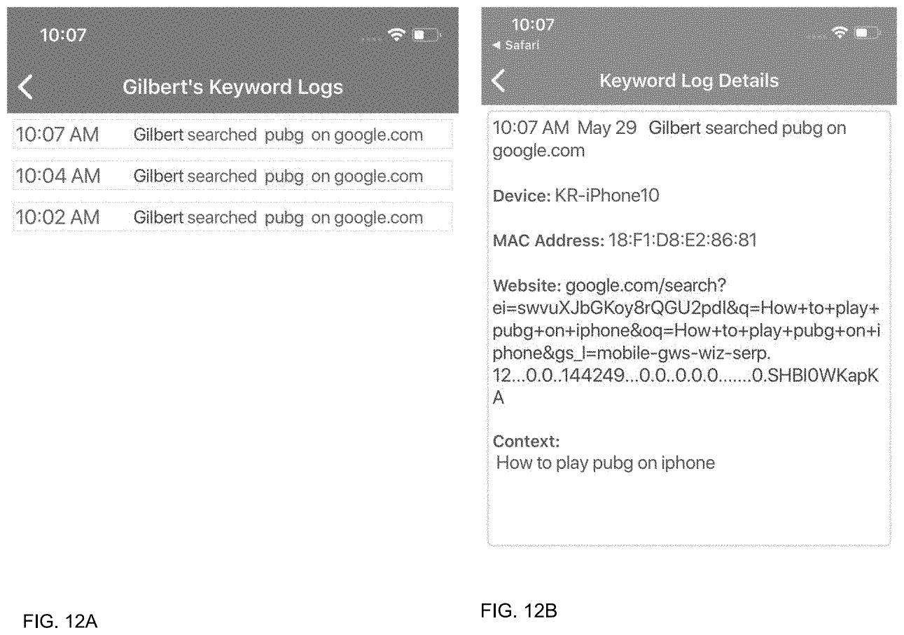

FIGS. 12A and 12B illustrate exemplary Keyword Log reports. FIG. 12A shows an exemplary overview page showing the log interface, which shows the times at which searches which triggered keywords were made. The user name is the name associated with the client device from which these searches were detected. FIG. 12B shows an exemplary detail page, which may be reached by selecting one of the searches, which shows the precise search, and other device information.

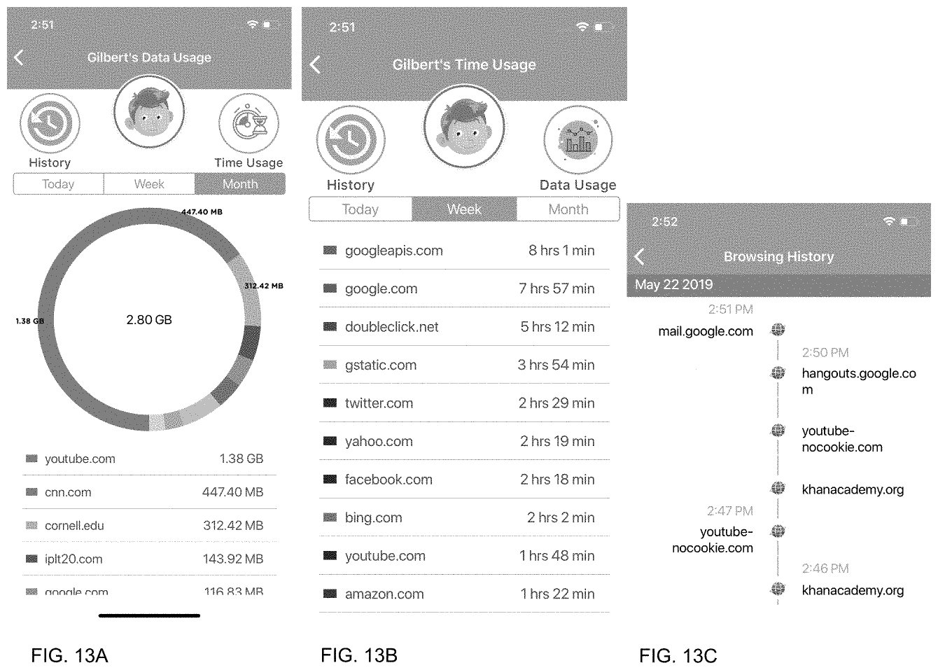

FIGS. 13A-13C illustrate exemplary Browsing history reports. Browsing activities of devices connected to the Router are recorded by the Router, in one embodiment, and sent to WebApp periodically. This data is stored in a database, in one embodiment. WebApp processes this data to generate various kinds of reports. Some exemplary reports that may be presented to the Policy Maker include:

Total amount of data consumed by a user/device over the day, week, and month

Total amount of time spent on the Internet using a device over the day, week and month

Detailed breakdown of d total consumed data and time on per domain basis

In one embodiment, the SWN system determines the domain to which the data and time usage is attributed. As mentioned, on many popular websites the content comes from various dependent domains, rather than directly from the website requested by the user. The Dependent domains mechanism is reused here to attribute the use of Dependent domains to the whitelisted domain which has referred the dependent domain for given request.

For example, if user opens whitelisted website “example.com” and it has multimedia content coming from “example-media.com” then all the data and time usage for “example-media.com” is attributed towards “example.com.” This means for example that even though various whitelisted websites may use akamai.com to serve webpages, the tool can disambiguate the originating whitelisted or partial website which caused the referral. This gives better idea of Internet usage to the Policy Makers.

FIG. 13A illustrates one example of a user interface showing the data usage of one of the users. In one embodiment, a single user may have multiple devices associated with them, and the system may aggregate the data, or provide separate per-device data in these browsing history reports.

FIG. 13B illustrates an example of a user interface showing time usage, by destination, on a daily, weekly, and/or monthly basis. FIG. 13C illustrates an example of a timeline based interface, showing the sequence of sites accessed by time. This provides an alternative way of evaluating the user's data usage.

Handling Native Applications

The above process works on websites accessed via any computing device, whether desktop or mobile application. However, sometimes native applications on a computer, whether mobile or desktop, have certain limitations that can cause issues with the above process. Those issues include the absence of Referer data, TLS certificate pinning, utilizing protocols other than HTTP/HTTPS, using direct IP address access rather than a DNS request. Those issues are laid out in more detail below.

Sometimes Native applications access resources/services over the Internet in different ways than web browsers. This section explains one embodiment of handling these ways by the SWN system.

Native applications running on the client devices may not include any information in the Referer field of an HTTP request, unlike web browsers which include Referer information. If Referer data is absent then the dependent domain detection and access control method described above is not applicable. However, if the system fully blocks access to dependent domains requested by native applications, the native applications may become partly or completely unusable. Therefore, an alternative approach is used.

Some Native Applications are pre-configured to accept only specific TLS server certificates during an initial TLS handshake with the Website. This method is used to prevent MITM (Man-In-The-Middle) intervention since any dummy TLS server certificate will never be accepted by the applications even if it is signed by a known Certificate Authority. In this document we refer to such websites as Pinned websites. SWN system uses MITM as described in earlier sections.

As described in the section of runtime workflow, every new TLS connection starts with TLS handshake between requesting client device and a website server. SWN system presents a TLS server certificate signed by SWN Certificate Authority instead of the certificate coming from the website server. Such certificate is not accepted by applications which use TLS certificate pinning since the SWN certificate does not match the expected website server certificate. In such cases, the TLS handshake gets aborted and no data communication happens.

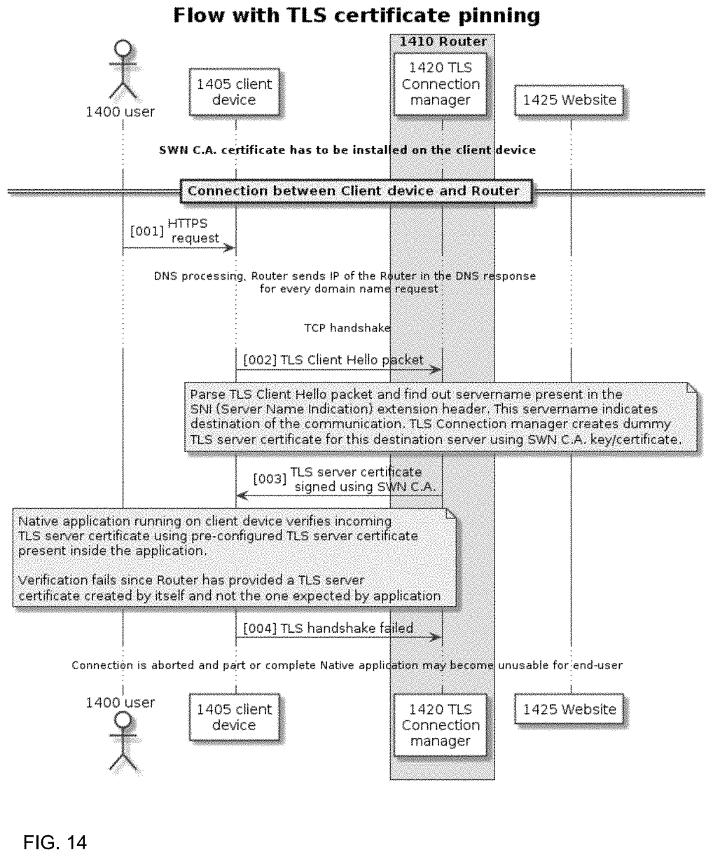

FIG. 14 illustrates one embodiment of the message flow in such an instance. Because the SWN router inserts its own SWN certificate in the process, the TLS handshake will fail, because it is not the certificate expected by the application.

Some native applications use networking protocols other than HTTP/HTTPS. Such protocols are not supported by SWN System, in one embodiment. Alternative methods of controlling access to resources using protocols other than HTTP/HTTPS are described below.

Most of the time, web browsers and native applications running on the client devices first make DNS request to find the IP address of the domain intended for further communication. SWN System monitors these DNS requests and gives DNS response in a way that the access to the requested domain can be allowed or denied. However sometimes native applications do not send a DNS request, and instead directly access a known IP address of the domain they intend to communicate with. Such requests get blocked by SWN system, in one embodiment.

In one embodiment, the SWN System provides a configuration option applicable to Native applications to address the above issues. Policy makers can select the Native applications which should run smoothly inside SWN Network, regardless of whether they use one of the above techniques which usually would otherwise disable the application. SWN system internally implements various ways to allow these applications to run.

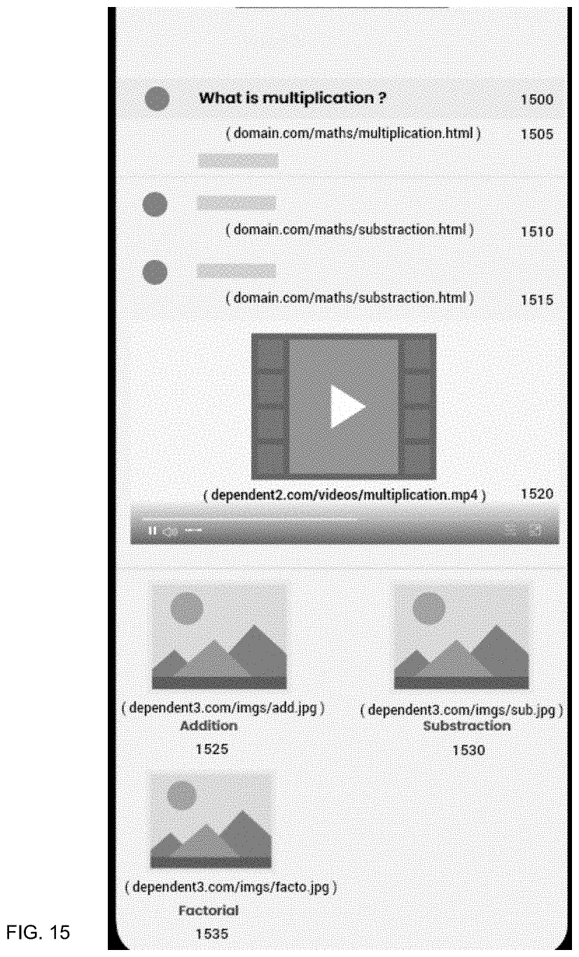

FIG. 15 shows layout of Native application corresponding to the same website “domain.com” described earlier, used for the discussion below. The domain, domain.com, includes video content from one dependent domain, and image content from two other dependent domains. These are the are web resources coming from “dependent1.com” and “dependent2.com” websites on this Native application.

| | Exemplary Solution by SWN System | Side-effect of the support |
|---|---|---|
| Absence of Referer | Grant access based on pre-populated | Reduced access control |
| | list of dependent domains | |
| TLS Certificate Pinning | Grant access to certificate | Weak access control |
| | pinning domains without MITM | Keyword monitoring not possible |
| Protocols other | Grant access to domains | Weak access control |
| than HTTP/HTTPS | without MITM | Keyword monitoring not possible |
| Direct access to IP address | Grant access to IP addresses | Weak access control |
| without DNS request | | Keyword monitoring not possible |

In one embodiment, in the absence of a Referer field, the system may utilize a list of dependent domains for the parent domains that is maintained at SWN WebApp. In one embodiment, this data may be obtained from two primary sources: Runtime detection by Router and/or Inspection of popular applications. This pre-populated list of dependent domains for the Native applications enabled by the Policy makers is provided to Router by the WebApp. Router uses this data to carry out access control decisions when Referer data is missing. Effectively this automatically whitelists dependent domains associated with sites accessed by these native applications.

In the example application, the requests to dependent1.com and dependent2.com do not include the Referer data. Still the requests are allowed since these domains exists in pre-populated list associated with the native application which accesses domain.com.

However, this does reduce access control. If dependent1.com is accessed directly, then it is allowed as well, which may not be desired since it is a dependent domain. Thus, access control is reduced, but still limited to identified dependent domains. In one embodiment, the dependent domain in the database has associated with it the native application which calls it. In one embodiment, the dependent domain can thus be freely accessed only via a the native application, and not via a browser or different application.

SWN system, in one embodiment, allows direct connection to the Certificate pinning domains. SWN Router does not send its IP address in DNS response to client device. Instead the client device receives the IP address of real Internet domain in response to its DNS request.

In one embodiment, a List of Certificate pinning domains and corresponding Native applications is maintained by the SWN. In one embodiment, this data is obtained from inspection of popular applications. When a Policy maker enables a Native application that uses certificate pinning, the WebApp sends the list of domains to Router. Router uses this list to allow the DNS requests for those domains directly without getting that traffic through MITM stack of SWN system. In one embodiment, the Policy maker is warned when they enable the Native application that this is required.

This does weaken access control, since if dependent1.com is also a certificate pinning domain, then it can be accessed directly, which is not desired since it is a dependent domain. Additionally because the access is direct, the system cannot provide keyword monitoring within that application.

In one embodiment, the SWN system does not handle protocols other than HTTP/HTTPS. Thus, in one embodiment it allows direct connection to the domains which use other protocols.

In one embodiment, a list of native applications that use other protocols is maintained along with the domains they use for that communication. In one embodiment, this list is built by inspection of popular applications.

Whenever a Policy maker enables any such Native application, they are warned. In one embodiment, the WebApp sends the corresponding list of domains to Router. Router uses this list in order to allow the DNS requests for those domains directly without passing that traffic through MITM stack of SWN system. This way direct communication happens between the Native application on the client device and such domains.

This approach weakens access control. If dependent1.com is one such domain using protocols other than HTTP/HTTPS, then it can be accessed directly, which is not desired since it is a dependent domain. Additionally, since direct access is enabled, the system cannot provide keyword monitoring for such domains.

In one embodiment, the SWN system builds and maintains a database of native applications and IP addresses used by those applications on WebApp.

If Policy maker allows any of such applications, then SWN WebApp shares the IP address list for selected applications with the Router. Router then allows access to those IP addresses directly. This traffic does not go through MITM stack of SWN system.

This weakens access control. There is risk of client device getting access to anything available on that IP address, which may include some other domains too. Additionally, since direct access is enabled, the system cannot provide keyword monitoring for such domains.

However, by providing such work-arounds the present system can provide improved security and monitoring of client device access to websites whether through a browser or through a native application.

In one embodiment, a Policy Maker may set policies on a per Native Application basis, just as they may on a per website basis. Thus, for example, the Policy Maker may set some Native Applications to “full access” which would provide the access described below. The Policy Maker may also set some other Native Applications to “domain only” access which disables dependent domains. This may break some applications. However, some Policy makers may prefer breaking some applications over potentially allowing access to problematic dependent domains.

### User Profiles

The features of the SWN system aid Policy makers in providing Access control and monitoring of the Internet activities of the users in the Network. In any Network, there are various types of users who co-exists. For example, in an enterprise Network there are employees in different functions like HR, Administration, IT, Marketing and at different levels like trainees, mid-level managers, VPs, or CXOs. In a home Network, the ages or maturity levels of kids differs. In such scenarios, the Policy maker may want to limit the Internet activities differently for each type of user. The Policy maker may prefer not to use same Access control and monitoring policy for every user on their Network.

The SWN system provides a way to manage these policies differently for different individual users and/or types of users. The support starts from the feature of User Profiles, where Policy maker can create a separate user profile for each individual user in the Network. The user profile in one embodiment is identified by a unique name which can be the name of the user or any other identification used by Policy maker. Each user profile is associated with one or more devices in the Network which are associated with that user.

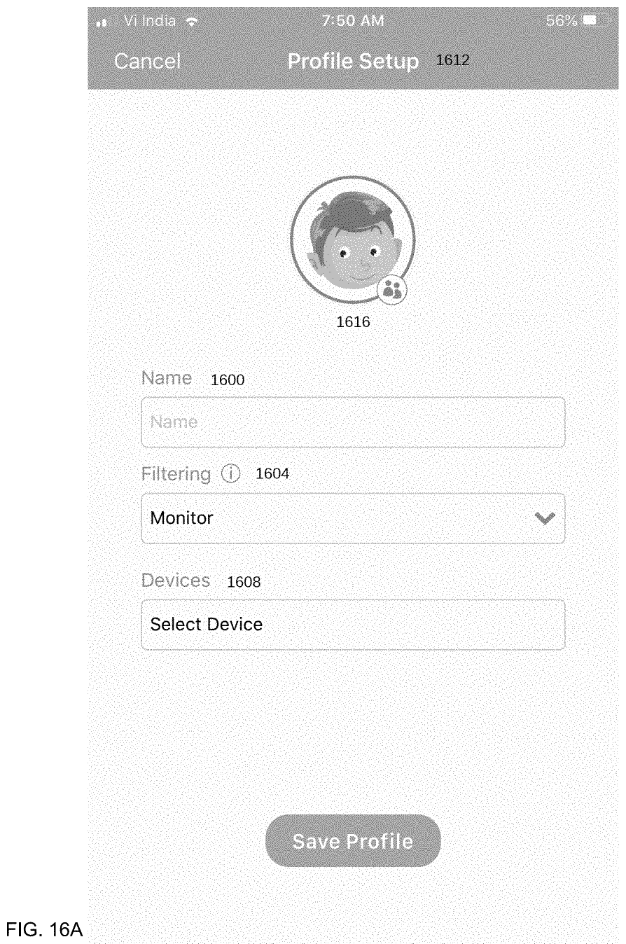

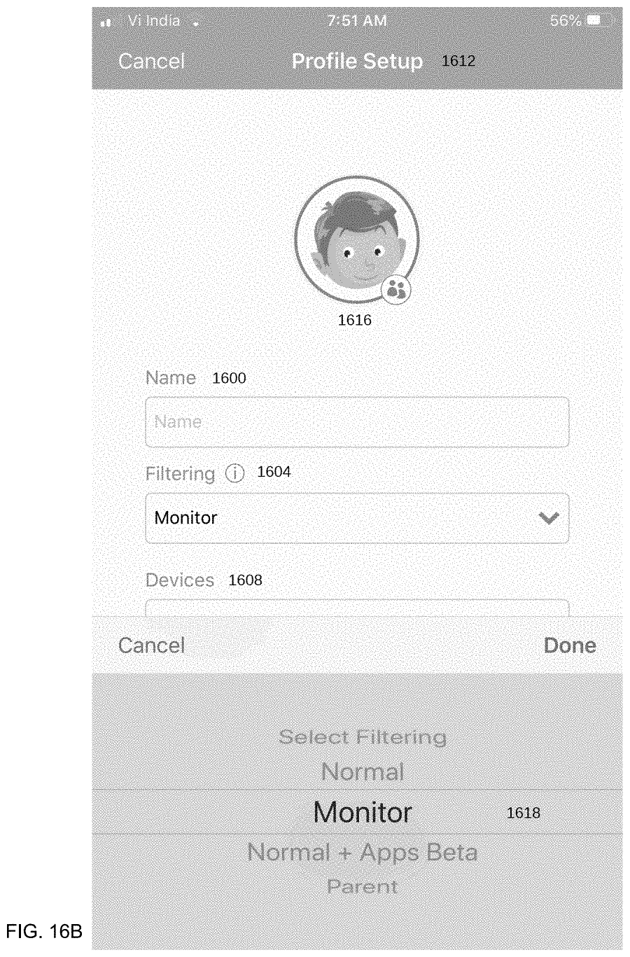

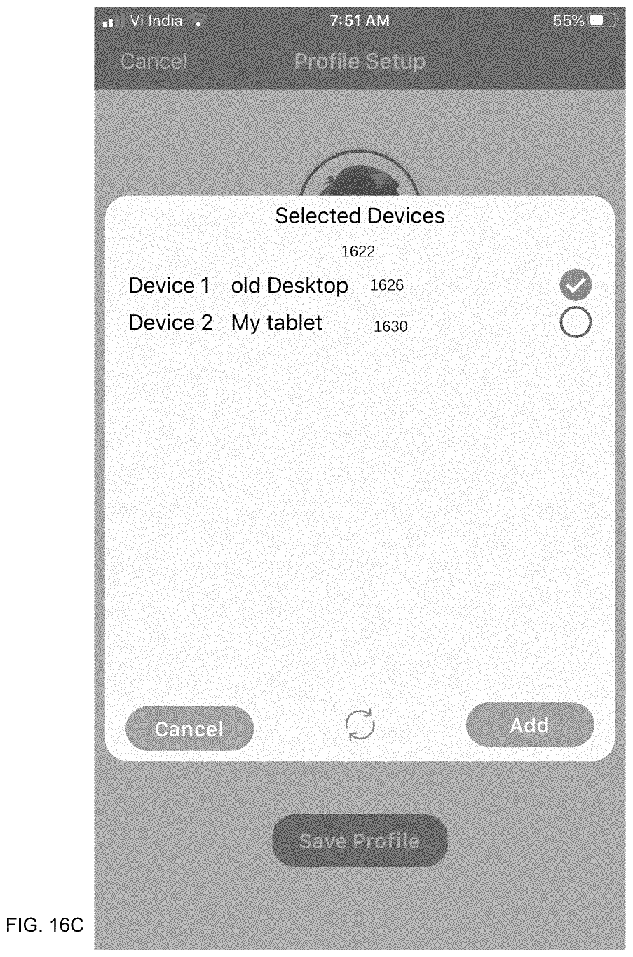

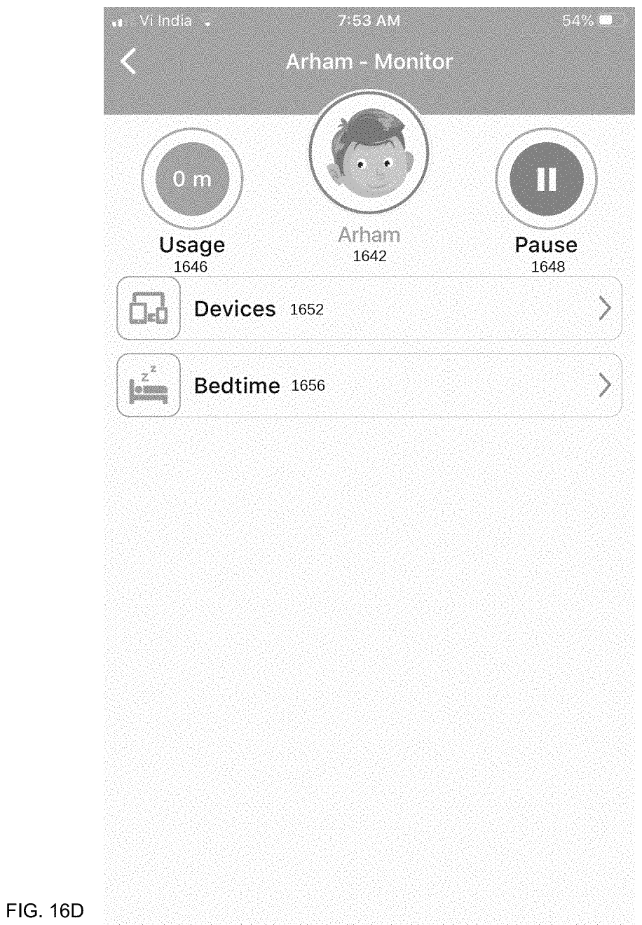

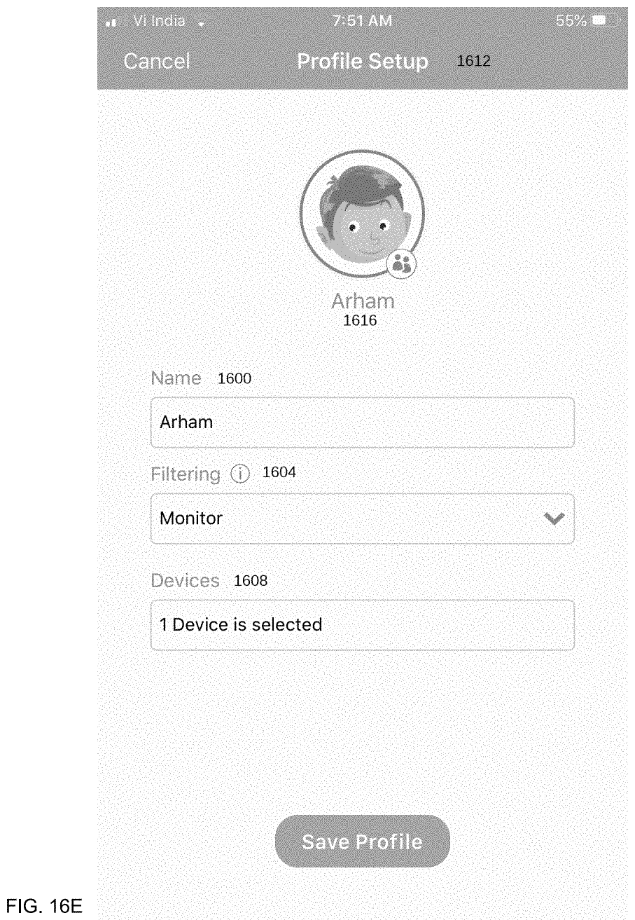

FIGS. 16A-16E illustrate embodiments of a User Profile. The user profile includes, in one embodiment, a unique name for the user 1600, the filtering setting for the user 1604, and the device(s) associated with the user 1608. In one embodiment, the Policy maker may also set a bedtime, or other interruption of permitted access, either ad hoc or based on a schedule.

In one embodiment, the features provided by SWN system are available on user profile level. This includes: completely whitelisted domains, partial domains, keyword detection, browsing history, configuration options for native applications etc.

Policy makers can configure the settings of each of these features differently for different user profiles based on the need. For example, the Policy maker can configure different list of websites to be allowed for each user profile.

In one embodiment, the Policy maker can provide policies per user type, rather than for each individual user. For example, in a large enterprise, there is no need to address each individual use to set up an individualized policy. In one embodiment, the system can interact with LDAP or another directory system and have policies associated with user categories as identified in such a directory.

In one embodiment, the SWN system provides a feature called Profile modes, to help Policy makers treat different user profiles differently in an organized manner. Policy makers need to associate every user profile with one particular profile mode. Each profile mode is meant for specific use cases and it comes with supported configuration options for Access control and Monitoring.

| | Profile Modes | | | |
|---|---|---|---|---|
| | | | Full Access | |
| | Plus Mode | Hybrid Mode | Active Mode | Full Access |
| | (Normal) | (Normal + Apps) | (Monitor Only) | Mode (Parent Mode) |
| Access Control based on | Yes | Yes | No | No |
| Completely whitelisted | | | | |
| and Partial domains | | | | |
| Pause/Resume Internet | Yes | Yes | Yes | No |
| and schedules | | | | |
| Keyword detection | Yes | Yes, partly | No | No |
| Browsing history | Yes | Yes | Yes | No |
| Native applications | No | Yes | Not needed | Not needed |
| configuration | | | | |

Plus Mode is the most restrictive mode. It supports all the features of SWN system except the native applications configuration. Hence the native application may not run smoothly on the devices of Plus mode User profiles. The features include access control based on white listing, as discussed above The features may also include the ability to set certain times when no network access is provided (pause/resume Internet and schedules), which may be useful to set a bedtime, or to block Internet access during school hours. This mode also includes keyword detection, browsing history tracking. This mode does not permit native applications to load data from websites even if the standard SWN approach does not work. Thus, it is the most restrictive mode.

Hybrid Mode supports native applications configuration in addition to all other features of SWN system. Inclusion of native applications support implies weaker security as discussed above.

Full Access Active Mode does not include any Access control based on domains. It includes tracking browsing, in one embodiment. It may include other monitoring, without access restrictions. .

Full Access Mode does not include any Access control nor any monitoring features. This is the mode available to the adults in a household setting, or the IT staff in an enterprise setting.

Alternative profile modes may be defined, either by the system or by a Policy Maker. In one embodiment, a Policy Maker can define one or more profiles, and associate each user with a profile. Alternatively, the Policy Maker may simply define the rules for each individual user, rather than using a Profile Mode approach.

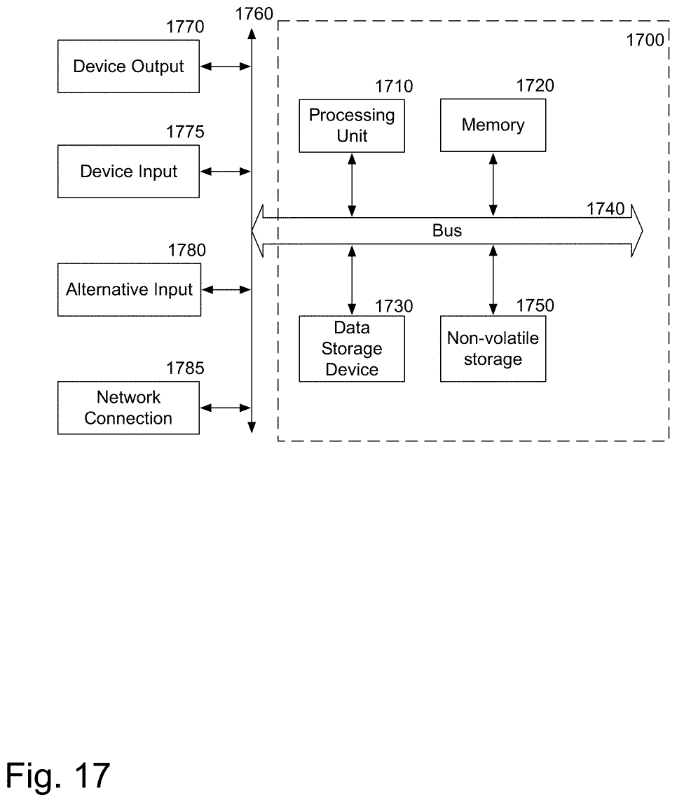

FIG. 17 is a block diagram of one embodiment of a computer system that may be used with the present invention. It will be apparent to those of ordinary skill in the art, however that other alternative systems of various system architectures may also be used.

The data processing system illustrated in FIG. 17 includes a bus or other internal communication means 1740 for communicating information, and a processing unit 1710 coupled to the bus 1740 for processing information. The processing unit 1710 may be a central processing unit (CPU), a digital signal processor (DSP), or another type of processing unit 1710.

The system further includes, in one embodiment, a random access memory (RAM) or other volatile storage device 1720 (referred to as memory), coupled to bus 1740 for storing information and instructions to be executed by processor 1710. Main memory 1720 may also be used for storing temporary variables or other intermediate information during execution of instructions by processing unit 1710.

The system also comprises in one embodiment a read only memory (ROM) 1750 and/or static storage device 1750 coupled to bus 1740 for storing static information and instructions for processor 1710. In one embodiment, the system also includes a data storage device 1730 such as a magnetic disk or optical disk and its corresponding disk drive, or Flash memory or other storage which is capable of storing data when no power is supplied to the system. Data storage device 1730 in one embodiment is coupled to bus 1740 for storing information and instructions.

The system may further be coupled to an output device 1770, such as a cathode ray tube (CRT) or a liquid crystal display (LCD) coupled to bus 1740 through bus 1760 for outputting information. The output device 1770 may be a visual output device, an audio output device, and/or tactile output device (e.g. vibrations, etc.)

An input device 1775 may be coupled to the bus 1760. The input device 1775 may be an alphanumeric input device, such as a keyboard including alphanumeric and other keys, for enabling a user to communicate information and command selections to processing unit 1710. An additional user input device 1780 may further be included. One such user input device 1780 is cursor control device 1780, such as a mouse, a trackball, stylus, cursor direction keys, or touch screen, may be coupled to bus 1740 through bus 1760 for communicating direction information and command selections to processing unit 1710, and for controlling movement on display device 1770.

Another device, which may optionally be coupled to computer system 1700, is a network device 1785 for accessing other nodes of a distributed system via a network. The communication device 1785 may include any of a number of commercially available networking peripheral devices such as those used for coupling to an Ethernet, token ring, Internet, or wide area network, personal area network, wireless network or other method of accessing other devices. The communication device 1785 may further be a null-modem connection, or any other mechanism that provides connectivity between the computer system 1700 and the outside world.

Note that any or all of the components of this system illustrated in FIG. 17 and associated hardware may be used in various embodiments of the present invention.

It will be appreciated by those of ordinary skill in the art that the particular machine that embodies the present invention may be configured in various ways according to the particular implementation. The control logic or software implementing the present invention can be stored in main memory 1720, mass storage device 1730, or other storage medium locally or remotely accessible to processor 1710.

It will be apparent to those of ordinary skill in the art that the system, method, and process described herein can be implemented as software stored in main memory 1720 or read only memory 1750 and executed by processor 1710. This control logic or software may also be resident on an article of manufacture comprising a computer readable medium having computer readable program code embodied therein and being readable by the mass storage device 1730 and for causing the processor 1710 to operate in accordance with the methods and teachings herein.

The present invention may also be embodied in a handheld or portable device containing a subset of the computer hardware components described above. For example, the handheld device may be configured to contain only the bus 1740, the processor 1710, and memory 1750 and/or 1720.

The handheld device may be configured to include a set of buttons or input signaling components with which a user may select from a set of available options. These could be considered input device #1 1775 or input device #2 1780. The handheld device may also be configured to include an output device 1770 such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above, such as a kiosk or a vehicle. For example, the appliance may include a processing unit 1710, a data storage device 1730, a bus 1740, and memory 1720, and no input/output mechanisms, or only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism. In one embodiment, the device may not provide any direct input/output signals, but may be configured and accessed through a website or other network-based connection through network device 1785.

It will be appreciated by those of ordinary skill in the art that any configuration of the particular machine implemented as the computer system may be used according to the particular implementation. The control logic or software implementing the present invention can be stored on any machine-readable medium locally or remotely accessible to processor 1710. A machine-readable medium includes any mechanism for storing information in a form readable by a machine (e.g. a computer). For example, a machine readable medium includes read-only memory (ROM), random access memory (RAM), magnetic disk storage media, optical storage media, flash memory devices, or other storage media which may be used for temporary or permanent data storage. In one embodiment, the control logic may be implemented as transmittable data, such as electrical, optical, acoustical or other forms of propagated signals (e.g. carrier waves, infrared signals, digital signals, etc.).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

We claim:

1. A method of providing policy-based access to Internet content, the method comprising:
receiving a request to access a website from a requesting device;
identifying a website domain;
identifying one or more dependent resources on the website, provided from one or more dependent domains;
comparing the website domain to a list of whitelisted domains; and
denying access to the website when the website domain is not in the list of whitelisted domains; and
when the website domain is in the list of whitelisted domain, and the one or more dependent resources on the website are from another domain, permitting access to the dependent resources at the dependent domain, to fully load the website.

2. The method of claim 1, wherein a software proxy acts as an intermediate broker between the requesting device and the website.

3. The method of claim 2, wherein the system enables the safe access to websites accessed via HTTPS.

4. The method of claim 3, comprising:
establishing a first secure connection between the website and a router that provides the website;
establishing a second secure connection between the requesting device and the router; and
passing content from the website through the router, enabling the safe access.

5. The method of claim 1, further comprising:
scanning messages from the requesting device for keywords; and
generating alerts in response to detected keywords.

6. The method of claim 1, further comprising:
enabling a policy maker to set a policy for each user in a network, the policy defining access to the Internet for each user, wherein the policy defines the list of whitelisted domains.

7. The method of claim 6, wherein the policy further defines availability of the dependent resources from the dependent domains.

8. The method of claim 1, wherein comparing the website domain to a list of whitelisted domains further comprising:
comparing a base URL to the list of whitelisted domains, and when the base URL is not in the list, comparing a partial domain of the website to a list of partially whitelisted domains.

9. The method of claim 1, further comprising:
examining a Referer field in an HTTP header to identify the dependent domain, and when the Referer is the website domain that is on the list of whitelisted domains, permitting access to the dependent domain.

10. The method of claim 1, further comprising:
analyzing a native application which accesses resources via the Internet; and
adding the dependent domains accessed by the native application to the list of whitelisted domains, to permit access when the native application prevents access to dependent domain data.

11. A system to provide policy-based access to Internet content, the system comprising a router to enforce rules of the safe access, the router comprising:
a connection manager to receive a request to access a website from a requesting device;
an HTTP parser to identify a website domain associated with an incoming HTTP request;
an access manager to determine whether the website domain is in a list of whitelisted domains;
the connection manager to establish a first connection between the connection manager and the website domain, and a second connection between the connection manager and the requesting device; and
the connection manager to provide data to the requesting device from the website.

12. The system of claim 11, further comprising when the website domain is not on the list of whitelisted domains:
a dependent domains manager to determine whether the website domain is to a dependent resource of whitelisted domain;
the access manager to deny access to the website when the website domain is not the dependent resource, and is not on the list of whitelisted domains; and
the access manager to permit access to the dependent resources at the dependent domain, to fully load the website.

13. The system of claim 11, wherein the system enables the safe access to websites accessed via HTTPS.

14. The system of claim 11, further comprising:
an HTTP parser to parse an HTTP request received from the requesting device;
a reporting manager to find keywords in the HTTP request; and
the reporting manager to generate a keyword report, when a keyword is detected.

15. The system of claim 11, further comprising:
a Web application configured to enable a policy maker to set a policy for each user in a network, the policy defining access to the Internet for each user, wherein the policy defines the list of whitelisted domains.

16. The system of claim 15, wherein the policy further defines availability of the dependent resources from the dependent domains.

17. The system of claim 11, wherein the access manager is further configured to comparing a base URL to the list of whitelisted domains, and when the base URL is not in the list, comparing a partial domain of the website to a list of partially whitelisted domains.

18. The system of claim 11, further comprising:
the access manager configured to use a Referer field in the HTTP header to identify the dependent domain, and when the Referer is the website domain that is on the list of whitelisted domains, permitting access to the dependent domain.

19. The system of claim 11, further comprising:
an application to manage the whitelisted domain list, the application to receive an analysis of a native application which accesses resources via the Internet, the analysis identifying the website domain and the dependent domains accessed by the native application; and
the application to add the dependent domains accessed by the native application to the list of whitelisted domains, to permit access when the native application prevents access to dependent domain data.
